(19) United States
(12) Patent Application Publication
(10) Pub. No.: US 2007/0080923 A1
(43) Pub. Date: Apr. 12, 2007

(54) AREA LIGHTING DEVICE AND LIQUID CRYSTAL DISPLAY DEVICE HAVING THE SAME

(76) Inventors: Hiromi Enomoto, Nara (JP); Susumu Okazaki, Kanagawa (JP); Hiroyuki Isogai, Kanagawa (JP)

Correspondence Address: SHARP KABUSHIKI KAISHA;C/O KEATING & BENNETT, LLP, 8180 GREENSBORO DRIVE, SUITE 850, MCLEAN, VA, 22102, US

(21) Appl. No.: 11/277,588

(22) Filed: Mar. 27, 2006

(30) Foreign Application Priority Data
Mar. 29, 2005 (JP) 2005-094526

(51) Int. Cl. G09G 3/36

(52) U.S. Cl. 345/102

(57) ABSTRACT

The invention relates to an area lighting device and a liquid crystal display device having the same. An object is to provide an area lighting device which can provide excellent display quality and a liquid crystal display device having the same. An area lighting device is configured to have a light source part provided with an LED module which has a plurality of LEDs that emits red, green and blue lights, and a light guide plate; a color sensor board which senses an intensity of lights from the LEDs and outputs detection signals of each of red, green and blue lights; an LED control part which controls the plurality of the LEDs based on the detection signals; and a gain setting part in the first stage and a gain setting part in the second stage which can change a gain setting for the detection signal.

### BACKGROUND OF THE INVENTION

1. Field of the Invention

The present invention relates to an area lighting device and a liquid crystal display device having the same.

2. Description of the Related Art

An active matrix liquid crystal display device having a TFT (Thin Film Transistor) as a switching device for each pixel can easily realize reduction in depth and weight as compared with a CRT, and can provide display quality equal to that of the CRT. Therefore, it is expected to become widely available as a display device for home television receivers and home OA appliances. The liquid crystal display device is demanded to respond not only to mobile information appliances such as notebook PCs but also to various multimedia information appliances as it profits from its capability of reduction in depth and weight. The liquid crystal display device is also demanded for excellent display quality with stable display brightness and chromaticity.

FIG. 7A is a perspective view schematically illustrating the configuration of a transmissive liquid crystal display panel provided on an active matrix liquid crystal display device which can provide high display quality among flat panel displays. FIG. 7B is a cross section schematically illustrating the configuration of the liquid crystal display panel. As shown in FIGS. 7A and 7B, the liquid crystal display panel has a TFT substrate 102 and a counter substrate 104 which are bonded to each other through a sealing material 152 coated there around, and a liquid crystal layer 106 encapsulated between the both substrates 102 and 104. The TFT substrate 102 is formed with a plurality of gate bus lines 112, and a plurality of drain bus lines 114 which intersects with the gate bus lines 112 through an insulating layer. At each of the intersecting parts of the bus lines 112 and 114, a pixel electrode is formed which is formed of a TFT 120 and a transparent conductive film. On the display area outer region of the TFT substrate 102, a gate bus line drive circuit 161 which drives the gate bus lines 112, and a drain bus line drive circuit 160 which drives the drain bus lines 114 are formed. Furthermore, on the TFT substrate 102, a terminal part 162 on which an external connection terminal is formed, and a protective film 163 which protects wirings of the terminal part 162 and the like are formed.

On the other hand, on nearly throughout the display area of the counter substrate 104, a common electrode 142 formed of a transparent conductive film is formed. The common electrode 142 is connected on the TFT substrate 102 side through a transfer 150, and held at common voltage. Liquid crystal capacitance Clc is formed of the common electrode 142, the pixel electrode, and the liquid crystal layer 106 sandwiched therebetween.

In addition to the transmissive liquid crystal display panel described above, the liquid crystal display device has a backlight unit disposed on the back side of the liquid crystal display panel. Liquid crystals in the liquid crystal display panel are driven at each of pixels, and the transmittance of light from the backlight unit is controlled to implement desired display. In recent years, for the backlight unit, various light sources such as CCFL, LED, and EL are used. The liquid crystal display panel has a drive circuit, and the backlight unit has a circuit for lighting a light source. The liquid crystal display device is formed to obtain excellent display quality by properly combining the liquid crystal display panel and the backlight unit.

Patent Reference 1: JP-A-11-295689

Patent Reference 2: JP-A-5-127602

In order to obtain more excellent display quality, the brightness control and white balance control of the backlight are required. However, in the liquid crystal display device before, it is difficult to properly control the brightness and white balance of the backlight, causing a problem that excellent display quality cannot be obtained.

### SUMMARY OF THE INVENTION

An object of the invention is to provide an area lighting device which can provide excellent display quality and a liquid crystal display device having the same.

The object can be achieved by an area lighting device including: a light source part in a plane shape which has a plurality of types of LEDs having luminous colors different from one another; a chromaticity sensor part which senses an intensity of lights from the plurality of the types of the LEDs, and outputs a plurality of detection signals; an LED control part which controls each of the plurality of the types of the LEDs based on the plurality of the detection signals; and gain setting parts in multiple stages which can change a gain setting of the plurality of the detection signals.

According to the invention, an area lighting device which can provide excellent display quality and a liquid crystal display device having the same can be implemented.

### BRIEF DESCRIPTION OF THE DRAWINGS

FIG. 1 is a diagram schematically illustrating the configuration of a liquid crystal display device of an embodiment according to the invention;

FIG. 2 is a block diagram illustrating the configuration of an area lighting device of Example 1 of an embodiment according to the invention;

FIG. 3 is a block diagram illustrating the configuration of an area lighting device of Example 2 of an embodiment according to the invention;

FIG. 4 is a diagram illustrating a modification of the essential configuration of the area lighting device of Example 2 of an embodiment according to the invention;

FIG. 5 is a diagram schematically illustrating the essential configuration of an area lighting device of Example 3 of an embodiment according to the invention;

FIG. 6 is a diagram schematically illustrating the essential configuration of an area lighting device of Example 4 of an embodiment according to the invention; and

FIGS. 7A and 7B are diagrams schematically illustrating the configuration of a liquid crystal display panel.

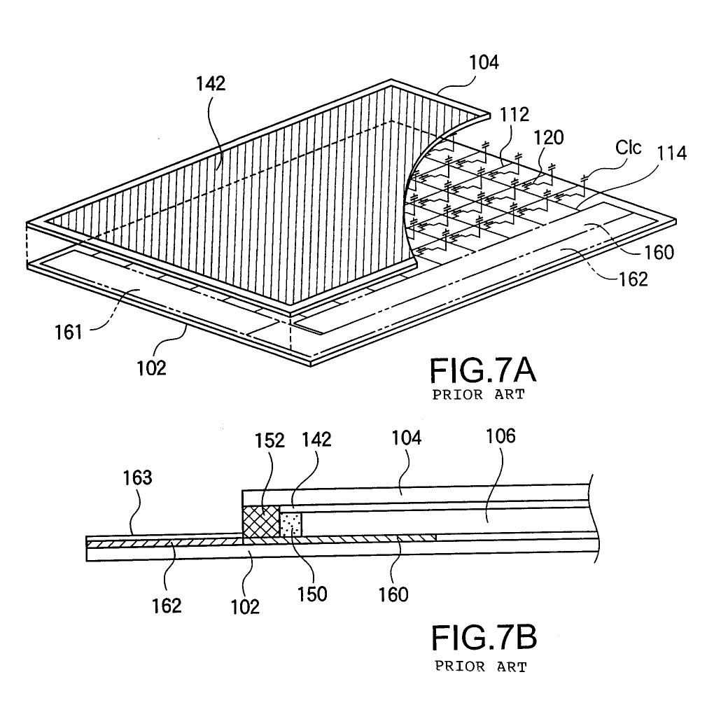

### DESCRIPTION OF THE PREFERRED EMBODIMENT

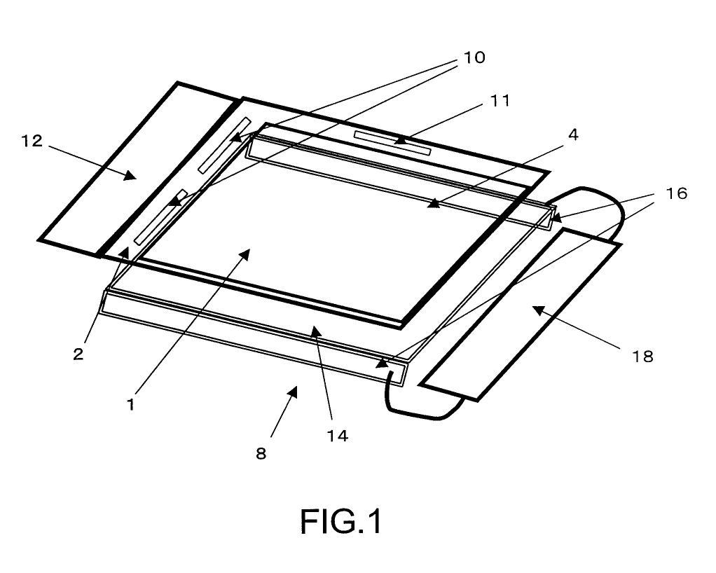

An area lighting device and a liquid crystal display device having the same of an embodiment according to the invention will be described in accordance with FIGS. 1 to 6. FIG. 1 schematically depicts the configuration of a liquid crystal display device according to the embodiment. As shown in FIG. 1, the liquid crystal display device has a transmissive liquid crystal display panel 1, and a backlight unit (area lighting device) 8 disposed on the back side of the liquid crystal display panel 1. The liquid crystal display panel 1 has a TFT substrate 2 which has a TFT and a pixel electrode for each of pixels, a counter substrate 4 which has a common electrode on the surface opposite to the TFT substrate 2, and a liquid crystal layer encapsulated between the both substrates 2 and 4. On the TFT substrate 2, a plurality of data bus lines (signal electrodes) and a plurality of gate bus lines (scanning electrodes) are formed as they intersect with each other.

When a certain gate bus line is selected and the TFTs connected to that gate bus line is turned on, gray scale voltage applied to the data bus lines is written to each of the pixel electrodes. Each of the pixels holds electric charge until that gate bus line is selected in the subsequent frame, and thus predetermined voltage is continuously applied to the liquid crystal layer between the pixel electrode and the common electrode. Since the tilt angle of liquid crystal molecules is determined in accordance with the applied voltage, the amount of light transmittance can be controlled at each of the pixels, and gray scale display is made possible. Furthermore, color filters of three colors, red (R), green (G), and blue (B), are formed for each of the pixels to mix three color lights, R, G and B lights, and thus color display is implemented. A circuit for driving the liquid crystal display panel 1 is configured of a gate bus line driver which drives each of the gate bus lines, a data bus line driver which drives each of the data bus lines, and a common voltage circuit which applies common voltage to the common electrode. A gate bus line driver IC 10 is disposed on one end side of the gate bus lines of the TFT substrate 2, and a data bus line driver IC 11 is disposed on one end side of the data bus lines. Moreover, to the TFT substrate 2, a peripheral circuit substrate 12 is connected.

The backlight unit 8 has a light source part in a plane shape. The light source part has a light guide plate 14 in a plane shape, and an LED module 16 near two end sides of the light guide plate 14 facing each other in which a plurality of LEDs is linearly arranged. The LED module 16 has a plurality of types of LEDs having luminous colors different from one another. For example, it has a plurality of LEDs that emits red light, a plurality of LEDs that emits green light, and a plurality of LEDs that emits blue light. Furthermore, the backlight unit 8 has an LED control part 18 which controls the LED module 16.

In the embodiment, a color sensor is disposed on one part of the backlight unit 8 (for example, on the back side of the light guide plate 14). The color sensor senses the intensities of R, G and B lights from the LEDs, and outputs detection signals of R, G and B lights. The LEDs of each color are feedback controlled based on each of the detection signals of R, G and B lights outputted from the color sensor, and thus brightness control and chromaticity correction (white balance control) of the light source can be done all the time. Moreover, in the embodiment, a gain setting part is disposed which can change gain settings of the detection signals to various values so that brightness control and chromaticity correction can be done variously in association with the brightness range and the chromaticity range. Since the gain setting part is generally disposed only on a color sensor board on which the color sensor is mounted, there is a problem that it is difficult to change a preset gain setting. On the other hand, a gain setting is changed relatively easier when a gain setting could be changed by an external signal, but excess signals and circuits are required. Therefore, there is a problem that it causes increases in size and fabrication costs of the backlight unit 8 and the liquid crystal display device. In order to solve the problem, in the embodiment, the gain setting parts in multiple stages are disposed. For example, the gain setting part in the first stage is placed on the color sensor board, and the gain setting part in the second stage is placed on the color sensor controller substrate (the LED control part 18) disposed separately from the color sensor board. Thus, this allows gain settings to be changed easily even after the power source is assembled in the device.

### EXAMPLE 1

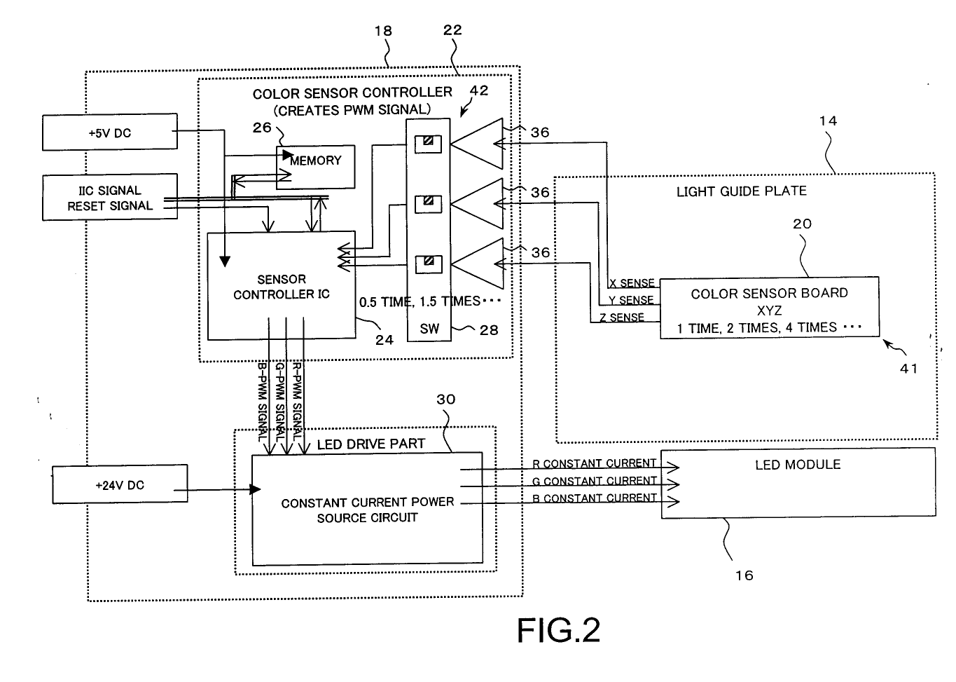

An area lighting device of Example 1 according to the embodiment will be described. FIG. 2 is a block diagram illustrating the configuration of a backlight unit according to this example. As shown in FIG. 2, a color sensor board (color sensor part) 20 is disposed on the back side of a light guide plate 14. On the color sensor board 20, a color sensor and a gain setting part 41 in the first stage are disposed. Each of detection signals of R, G and B lights (an X-sense signal, a Y-sense signal, and a Z-sense signal) outputted from the color sensor is amplified by the gain setting part 41 in the first stage at a predetermined gain, and inputted to a color sensor controller 22 of an LED control part 18. The color sensor controller 22 has a sensor controller IC 24, memory 26 which stores predetermined items of information, and a gain setting part 42 in the second stage which has an amplifier circuit 36 and a switch (SW) 28. In the gain setting part 42 in the second stage, the switch 28 is switched to change gain settings of each of the detection signals of R, G and B lights in which each of the detection signals of R, G and B lights inputted from the color sensor board 20 is amplified at a predetermined gain, and outputted to the sensor controller IC 24. To the sensor controller IC 24 and the memory 26, +5 V DC of a power source is supplied from outside, and an IIC signal and a reset signal are inputted and outputted. The color sensor controller 22 creates and outputs PWM signals (an R-PWM signal, a G-PWM signal, and a B-PWM signal) based on the inputted detection signals of R, G and B lights and equations set beforehand.

The PWM signals are inputted to a constant current power source circuit 30 which is an LED drive part that drives an LED module 16. To the constant current power source circuit 30, +24 V DC of a power source is supplied from outside. The constant current power source circuit 30 flows constant currents (R constant current, G constant current, and B constant current) to LEDs of each color of the LED module 16 based on the PWM signals. The LEDs of each color emit light at brightness nearly proportional to the current amount. In this manner, the LED control part 18 feedback controls the current amount to flow in each of the R, G and B LEDs in the PWM control mode based on each of the detection signals of R, G and B lights outputted from the color sensor and each amplified at the gain setting part 42 in the second stage for brightness control and chromaticity correction. In addition, brightness control and chromaticity correction may be done by controlling voltage applied to the LEDs, not by controlling the current amount to flow in the LEDs.

In this example, the gain setting parts 41 and 42 are disposed on both of the color sensor board 20 and the color sensor controller 22. As compared with the color sensor board 20 disposed on the back side of the light guide plate 14, a switch 28 in the color sensor controller 22 is easily switched. Therefore, since the gain setting part 42 in the second stage is particularly disposed on the color sensor controller 22, gain settings can be changed easily in association with variations in the brightness range or the chromaticity range, and brightness control and chromaticity correction can be done. Furthermore, for example, changeable gain settings are set equal, twofold, fourfold, and so on in the gain setting part 41 in the first stage on the color sensor board 20 side, and are set to 0.5-fold, 1.5-fold and so on in the gain setting part 42 in the second stage on the color sensor controller 22 side. In this manner, a plurality of gain settings is prepared for the gain setting parts in multiple stages, and thus brightness control and chromaticity correction can be done in association with changes of gain settings for an LED backlight having different ranges of brightness and chromaticity. In addition, gain settings in the first stage in the gain setting part 41 on the color sensor board 20 side are done before the power source is assembled in the device, and gain settings in the second stage in the gain setting part 42 on the color sensor controller 22 side can be done as the gain settings in the first stage are fixed.

### EXAMPLE 2

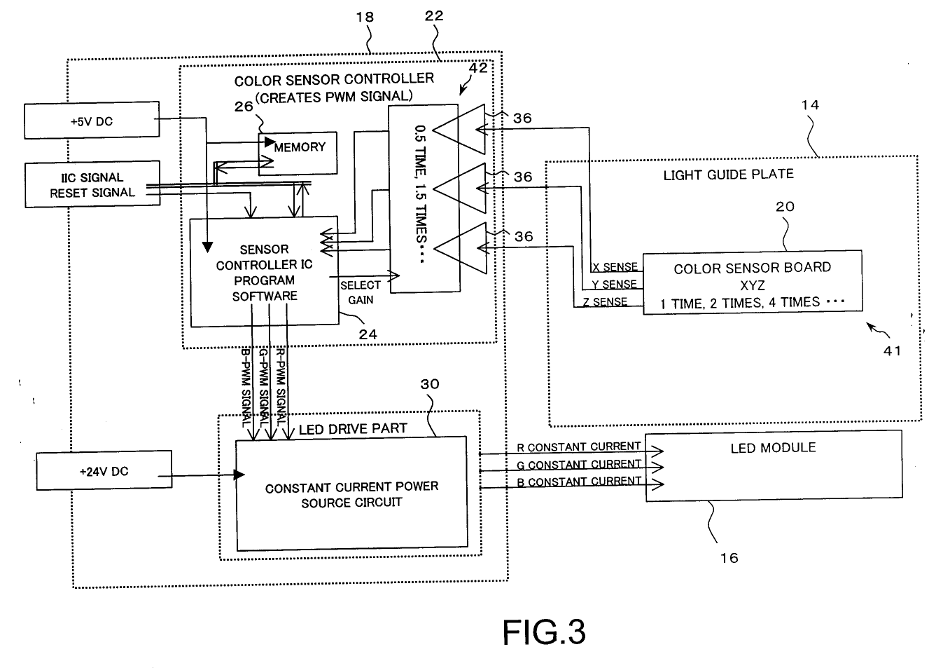

Next, an area lighting device of Example 2 according to the embodiment will be described. FIG. 3 is a block diagram illustrating the configuration of a backlight unit according to this example. In Example 1, the mechanical switch 28 is used to change the gain settings in the second stage, whereas in this example, as shown in FIG. 3, program software is used to change the gain settings in the second stage. The program software for changing gain settings is incorporated in a sensor controller IC 24. For example, the sensor controller IC 24 selects gain settings in the second stage for each of R, G and B lights based on the brightness and color temperature of the backlight as gain settings in the first stage are fixed.

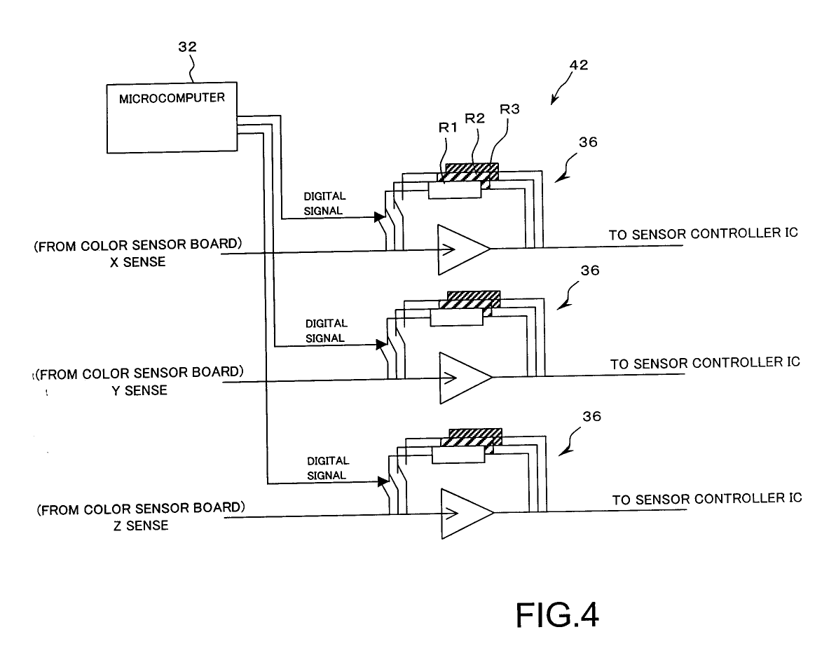

FIG. 4 depicts a modification of the essential configuration of the backlight unit. A color sensor controller 22 in FIG. 3 is provided with a microcomputer 32 having program software for changing gain settings in the gain setting part 42. The microcomputer 32 outputs predetermined digital signals to each of amplifier circuits 36 based on the brightness and color temperature of the backlight, for example. Each of the amplifier circuits 36, for example, is provided with resisters R1 to R3 having resistance values different from one another. The digital signals outputted from the microcomputer 32 switch the resisters R1 to R3 which determine the gain of each of the amplifier circuits 36, and the gain settings are changed.

### EXAMPLE 3

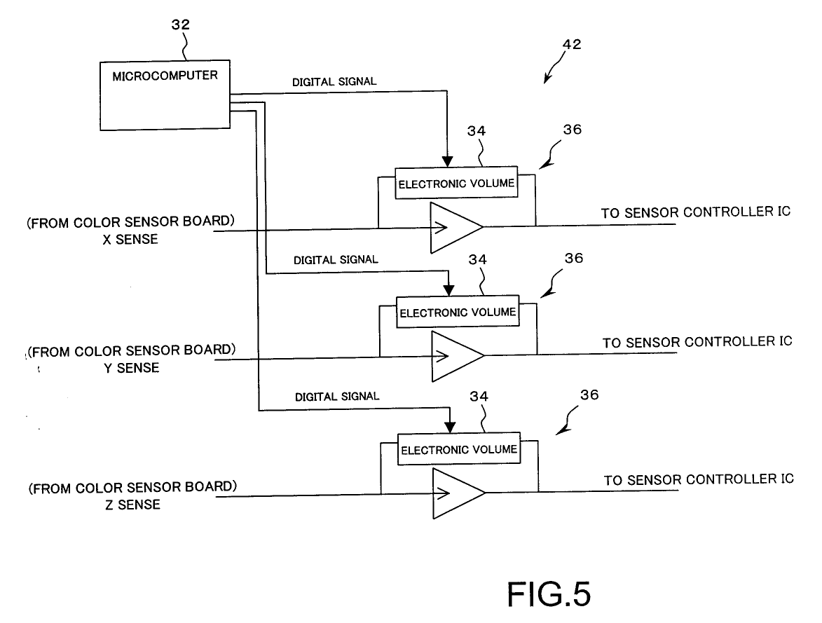

Next, an area lighting device of Example 3 according to the embodiment will be described. FIG. 5 schematically depicts the essential configuration of a backlight unit according to this example. As shown in FIG. 5, each of amplifier circuits 36 of a gain setting part 42 in the second stage has an electronic volume 34 which can control a resistance value by a digital signal. The resistance value of each of the electronic volumes 34 is changed based on the digital signal outputted from a microcomputer 32 to change the resistance value that determines the gain of each of the amplifier circuits 36. In this example, since it is unnecessary to switch the resisters by the switch, gain settings in the second stage can be changed in finer steps based on the brightness and color temperature of the backlight.

### EXAMPLE 4

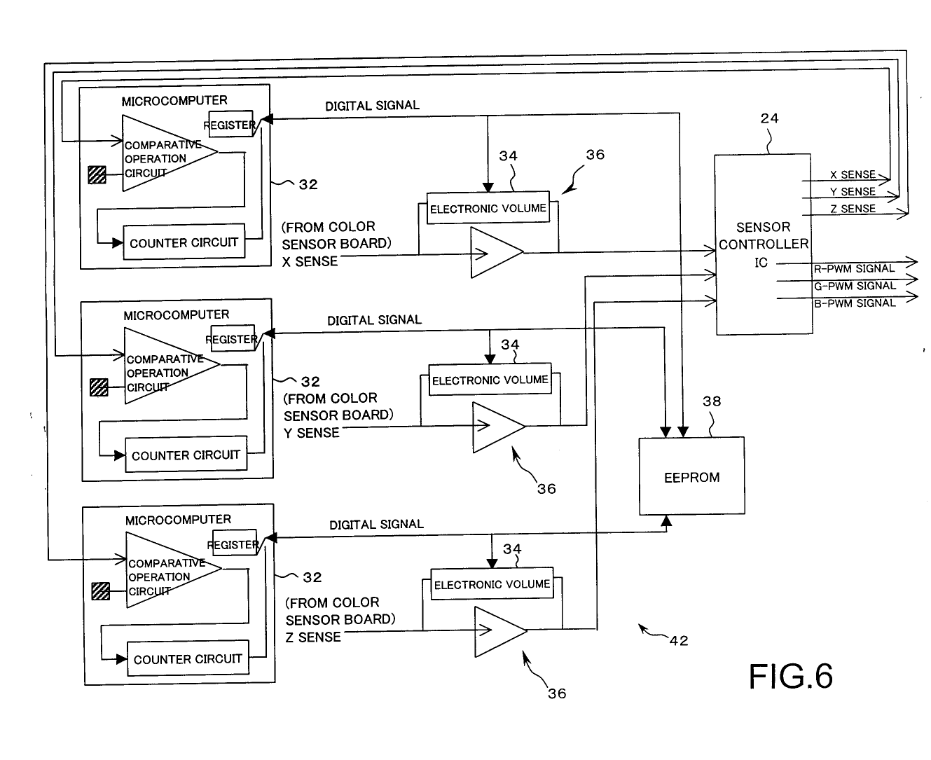

Next, an area lighting device of Example 4 according to the embodiment will be described. FIG. 6 schematically depicts the essential configuration of a backlight unit according to this example. As shown in FIG. 6, in this example, a sensor controller IC 24 creates PWM signals based on output signals from color sensors, and outputs X-, Y- and Z-sense signals to microcomputers 32. The microcomputer 32 has a comparative operation circuit, a counter circuit, a register and the like, which performs comparative operation based on each of the inputted sense signals, and outputs digital signals for gain setting to an electronic volume 34. The resistance value of the electronic volumes 34 is changed based on the digital signals outputted from the microcomputers 32, and then the resistance value that determines the gain of each of the amplifier circuits 36 is changed. In this example, it is unnecessary for a user to make decision and operation, and a proper gain setting is automatically selected by feedback control (automatic gain control (AGC)). Initial data for gain settings is stored in EEPROM (memory part) 38 and the like before the device is shipped. In general operation, the microcomputer 32 reads data stored in the EEPROM 38, and writes it in the register for gain settings. When a gain setting is changed, the microcomputer 32 may delete initial data stored in the EEPROM 38, and write and store new gain setting data in the EEPROM 38.

As described above, in the embodiment, the color sensor is provided in one part of the backlight unit 8, and the brightness control and chromaticity correction of the backlight light source is done by each of the detection signals. To the color sensor board 20 and the color sensor system circuit (the color sensor controller 22) of the LED control part 18, the gain setting parts are provided respectively, which can change gain settings for sensor values matched with a plurality of the brightness ranges and a plurality of the chromaticity ranges. Therefore, brightness control and chromaticity correction can be done easily. It is unnecessary to exchange the color sensor even when brightness is changed and when LED devices are exchanged, and proper gain settings can be done easily. Furthermore, brightness control and chromaticity correction can be done all the time. Moreover, as in Example 4, when the electronic volume 34 is used to feed the detection signal back to allow automatic gain control, and more proper gain settings can be done easily. As described above, according to the embodiment, excellent display quality with stable brightness and chromaticity can be obtained, and a thin, spare-saving area lighting device and a liquid crystal display device having the same can be provided.

The invention can be modified variously, not limited to the embodiment.

For example, in the embodiment, a sidelight backlight unit is taken as an example in which an LED is disposed at least near one end of the light guide plate, but the invention is not limited thereto, which can be applied to a direct backlight unit as well.

What is claimed is:

1. An area lighting device comprising:
a light source part in a plane shape which has a plurality of types of LEDs having luminous colors different from one another;
a chromaticity sensor part which senses an intensity of lights from the plurality of the types of the LEDs, and outputs a plurality of detection signals;
an LED control part which controls each of the plurality of the types of the LEDs based on the plurality of the detection signals; and
gain setting parts in multiple stages which can change a gain setting of the plurality of the detection signals.

2. The area lighting device according to claim 1, wherein in a state in which a gain setting in one part of the gain setting parts is fixed in the gain setting parts in multiple stages, a switch is used to change a gain setting in the other gain setting part.

3. The area lighting device according to claim 1, wherein in a state in which a gain setting in one part of the gain setting parts is fixed in the gain setting parts in multiple stages, program software is used to change a gain setting in the other gain setting part.

4. The area lighting device according to claim 1, wherein in a state in which a gain setting in one part of the gain setting parts is fixed in the gain setting parts in multiple stages, an electronic volume is used to change a gain setting in the other gain setting part.

5. The area lighting device according to claim 4, wherein the LED control part changes a gain setting in the other gain setting part based on the plurality of the detection signals.

6. The area lighting device according to claim 5, wherein the LED control part has a memory part which stores a changed gain setting.

7. The area lighting device according to claim 2, wherein the part of the gain setting part is disposed on the chromaticity sensor part, and the other gain setting part is disposed on the LED control part.

8. A liquid crystal display device comprising:
an area lighting device; and
a liquid crystal display panel illuminated by the area lighting device,
wherein the area lighting device according to claim 1 is used as the area lighting device.
